(19) United States
(12) Patent Application Publication
(10) Pub. No.: US 2007/0238602 A1
(43) Pub. Date: Oct. 11, 2007

(54) Refractory Article for Guiding or Conveying a Solidified Material and Process for the Manufacture Thereof

(75) Inventors: Gilbert Rancoule, Marcq-En-Baroeul (FR); Jacky Deremetz, Neuf Mesnil (FR)

Correspondence Address: VESUVIUS CRUCIBLE COMPANY, 27 NOBLESTOWN RD, CARNEGIE, PA, 15106-1632, US

(73) Assignee: VESUVIUS CRUCIBLE COMPANY, WILMINGTON, DE (US)

(21) Appl. No.: 10/594,209

(22) PCT Filed: Apr. 1, 2005
(86) PCT No.: PCT/BE05/00045

§ 371 Date: Sep. 25, 2006

(30) Foreign Application Priority Data
Apr. 2, 2004 (EP) 04447084.7

(51) Int. Cl. C04B 35/66; C03B 19/06; C03C 14/00; F27D 3/02; C04B 35/01

(52) U.S. Cl. 501/102; 501/108; 501/123; 501/125; 501/133

(57) ABSTRACT

The present invention relates to refractory articles for guiding or conveying a solidified material comprising a vitreous silica basis, in particular rollers or guiding elements and to a process for the manufacture of said articles which do not show the pickup problems normally observed with the articles of the art. The refractory articles of the invention comprise a vitreous basis and, homogeneously distributed therein, a carbonaceous material.

The present invention relates to refractory articles for guiding or conveying a solidified material comprising a vitreous silica basis and to a process for the manufacture of said articles.

Vitreous silica is the generic term to designate the glassy (amorphous or non crystalline) form of silicon dioxide. High purity sand or quartz deposits provide the raw material which is electric arc melted at very high temperature to provide respectively fused silica or fused quartz. Vitreous silica can routinely withstand temperature of over 1250° C., and due to its very low coefficient of thermal expansion can be rapidly heated and cooled with virtually no risk of breakage due to thermal shock. It is tough and hard so that articles made therefrom exhibits good surface damage resistance and superior wear resistance.

Typically, vitreous silica exhibits a (bulk) density of 1.8 to 2.2 g/cm³, a coefficient of thermal expansion (at room temperature) of 0.50 to 0.95 10⁻⁶/° C., a thermal conductivity of 0.62 to 1.38 W/m. ° K and an apparent porosity of 7 to 16%.

A number of industrial applications of vitreous silica taking advantage of these properties are known. For example, it can be used as conveyor roller for the transfer of solidified material (such as metal or glass) in the form of sheet, strip or foil in a furnace or as guide for a solidified metal wire in a galvanisation bath.

It has been found that the surface of vitreous silica rollers forming the conveyors used for transferring sheets, strips or foils through a furnace or of articles forming the guide for a wire in a galvanisation bath tends to collect deposit of material from the sheets, strips, foils or wires so that sheets, strips, foils or wires passing thereover become marked, scratched and/or dented. The phenomenon of deposit formation is complex and is influenced by the composition of the sheets, strips, foils or wire carried or guided by the article and the composition and temperature of the installation as well as the character of the article surface. Such a deposit is referred to as build-up or pickup and is hereinafter referred to as pickup.

Such marked sheets, strips, foils or wire, of course, are not perfect and must be scrapped or given an inferior grade. The simple replacement of these articles while maintaining the installation hot is not always possible so that when the articles reach this stage of pickup, it is often necessary to shut down the installation until the article can be polished by grinders or even replaced. This shutting-down is a long process and a serious curtailment for the production. A period of several days may be necessary for cooling down the installation and further time is required for the actual polishing or replacement of the articles before the installation can again be placed in service. Even in the cases when it is possible to replace the articles without having to shut down the whole installation, this requires the uneasy manipulation of hot and heavy articles and raises other problems.

In a known application “scrapper” rollers are used to convey a flat glass ribbon between the end of a molten tin bath and the beginning of an annealing line. Shaped carbon blocks are provided under the scrapper rollers to scrap the surface of the rollers and remove any tin carried by the glass ribbon and released at the surface of the roller. As a matter of fact, it has been observed that the scrapper blocks force some tin into the porosity of the roller. After years of service, a substantial proportion of the tin is oxidized. The resulting tin oxide damages the roller surface and marks the glass ribbon.

In another known application (described for example in U.S. Pat. No. 4,412,503) refractory segments of vitreous silica are used to guide a steel wire in a galvanisation bath. After some time, an important pickup of mixed tin and iron oxides can be observed at the surface of the segment, in contact with the wire, resulting in a serious marking of the wire.

Several attempts have been made in that art to try to improve the properties of vitreous silica with respect to pickup. So far, the most common approach has been to use a material other than vitreous silica for particularly demanding applications (such as high silicon steel for example). It has thus already been suggested to provide the rollers with special alloy coatings (U.S. Pat. No. 2,695,248), or to use a shaft made from a particular steel grade (U.S. Pat. No. 4,470,802).

It has also been proposed to use a roller made from a different material such as graphite or having a layer made from a material with a lamellar structure such as talc, graphite or boron nitride (FR-A1-2672586).

Some good results have been obtained with relatively “soft” graphite rollers or graphite coated rollers which do not tend to accumulate pickup at their surface. With such articles, it has been observed that the outer layer of the articles on which the pickup is formed tends to be eroded by the sheets, strips or foils carried by the articles faster than the deposit formation so that no pickup can be observed. An obvious disadvantage of such articles being that due to their weak erosion resistance, they must also often be replaced with all the above discussed problems.

It is therefore an object of the present invention to provide refractory articles for guiding or conveying a solidified material which possess the excellent mechanical properties of vitreous silica articles without showing the pickup problems normally observed with the articles of the art. Such articles should also have a prolonged service life.

These problems and others have been solved with articles according to claim 1.

According to a first embodiment, the vitreous silica basis is comprised of a chemically bonded (cement bonded and/or resin bonded) vitreous silica aggregate. Typically, the chemically bonded vitreous silica aggregate is prepared from a mixture comprising (i) at least 75 wt. %, preferably more than 85 wt. %, of amorphous silica, (ii) from 2 to 23% of a chemical binder and (iii) water. Suitable chemical binders are calcium aluminate, calcium silicate, polyalkoxysiloxanes such as polydiethoxysiloxane (ethylsilicate), colloidal silica, aluminium or zirconium acetate, magnesium oxide, and the like or mixtures thereof. Calcium aluminate is the preferred binder. The mixture is shaped and then dried. It is generally not necessary to fire such a chemically bonded vitreous silica aggregate. The dried chemically bonded vitreous silica aggregate comprises generally from 75 to 96 wt. % of vitreous silica, from 2 to 23 wt. % of the chemically binder and from 2 to 4 wt. % of water.

According to a second and preferred embodiment, the vitreous silica basis comprises generally at least 60 wt. % of amorphous silica, preferably more than 90 wt. %, more preferably more than 95 wt. % and typically more than 99 wt. %. The vitreous silica forms a matrix and can be obtained by any known process for the preparation of a vitreous silica matrix such as slip casting or injection moulding. The vitreous silica, once shaped is fired. The shape is generally densified by sintering at temperature above 1000° C.

According to the invention, such articles may be prepared with a process according to claim 6. This process can be carried out on a freshly formed article or on a recycled article (after having machined the surface).

Advantageously, refractory articles comprising a vitreous silica basis are impregnated with a liquid carbonaceous material such as tar (pitch) or resin. The carbon impregnation reduces the apparent porosity to as low as about 2% or less which, beside reducing the pickup, also serves to further protect the refractory silicon oxide from corrosive attack which otherwise can occur. Articles to be impregnated are placed into a vessel and air is evacuated. The vacuum is maintained between 15 minutes and 1 hour. This ensures that entrapped air within the internal pores of the article is removed. At this point, liquid resin or tar is introduced into the vessel. The required viscosity of the impregnant is dependent on the pore size of the article. A piece with finely distributed porosity requires low viscosity impregnant to ensure adequate impregnation. The viscosity range is typically between 10-100 centipoise. Higher viscosity resins can be used if thinned with appropriate solvents. Once the impregnant has been introduced to the vessel, a pressure between 5 and 25 bars is typically applied to force the resin or tar into the porosity. This completes the impregnation process. Suitable carbonaceous materials for the impregnation of the vitreous silica basis are tar or pitch as well as resins (for example phenolic resins).

Optionally, the article can be heated up to 300° C. before or during the impregnation process in order to ensure adequate impregnation.

An impregnated article is then optionally dried (for example at 90° C.) and then heated up to 200° C. to 750° C. up to 10 hours to drive off low temperature volatile compounds. The cured resin or tar can be carbonised to give fixed carbon by heating up to 950° C. in a reducing or inert atmosphere for up to 24 hours.

Advantageously, the vessel can be highly pressurised (up to 25 bars) to promote the cracking of the cured resin or tar.

The impregnated article comprises from 1 to 6 wt. % of carbonaceous material. If necessary, the article can be subjected to several impregnation steps to reach the desired amount of carbonaceous material. It is to be noted that the article can be impregnated on several millimeters from its surface or on its whole thickness.

In particular, such an article exhibits a surprisingly low tendency to pickup while presenting all the above discussed excellent properties of a vitreous silica article, in particular the resistance to erosion. Consequently, such articles have a particularly long service life before requiring any grinding or replacement. Conveyor units comprising a plurality of such rollers are advantageously used for the transport of material in the form of sheet, strip or foil in very demanding application such as for the transport of sheet, strip or foil of high silicon steel (oriented grains), stainless steel in an annealing furnace or in a galvanisation line or for the transport of sheet, strip or foil of glass.

As an example two vitreous silica rollers according to the invention have been manufactured and compared with the very same roller but the carbonaceous material. Table I shows various properties measured for the rollers (roller 3 and 4) according to the invention compared with the same roller before its impregnation with the carbonaceous material (roller 1). Another roller (roller 2; comparative example) is identical to roller 1 with a 0.2 mm coating of graphite. Roller 3 is impregnated with pitch; roller 4 is impregnated (on 3 mm) with a phenolic resin.

TABLE I

| | Roller 1 | Roller 2 | Roller 3 | Roller 4 |
|---|---|---|---|---|
| Absolute (bulk) density | 2.208 | 2.208 | 2.161 | 2.039 |
| (kg/dm³) | | | | |
| Relative density (kg/dm³) | 1.984 | 1.984 | 2.030 | 1.977 |
| Open porosity | 10.14% | 7% | 6.1% | 3.05% |
| Average Modulus of rupture | 32.674 | 32.674 | 33.984 | 35.123 |
| (MPa) | | | | |
| Average Pore diameter (μm) | 0.11 | 0.050 | 0.057 | 0.050 |
| Carbon content (wt. %) | 0 | Surface: | 2.16% | Surface: |
| | | 100% | | 4.30% |
| | | Core: 0 | | Core: 0 |

Rollers 1 and 2 have been installed into a conveyor unit for the transport of high silicon steel strips. The surface of rollers 1 and 2 and of the transported strips was regularly checked during their service life and the results are reported in Table II.

TABLE II

| Control time | Roller 1 | Roller 2 | Roller 3 | Roller 4 |
|---|---|---|---|---|
| 15 days | A, E | A, E | A, E | A, E |
| 1 month | B, E | B, E | A, E | A, E |
| 2 months | B, F | B, E | A, E | A, E |
| 3 months | C, G | C, F | A, E | A, E |
| 6 months | C, G | C, G | A, E | A, E |
| 12 months | D, G | D, G | B, E | A, E |
| 18 months | — | — | B, F | B, E |

Legend:
A: no pickup can be observed.
B: some pickup can be observed with a magnifier.
C: some pickup can be visually observed.
D: important pickup. The roller has to be replaced.
E: transported strips are not marked.
F: transported strips are slightly marked.
G: transported strips are so marked that they have to be given a lower grade.

1-7. (canceled)

8. A refractory article for guiding or conveying a solidified material comprising vitreous silica impregnated with a carbonaceous material.

9. The refractory article according to claim 8, wherein the article comprises 1 to 6 wt. % of carbonaceous material.

10. The refractory article of claim 8, wherein the refractory article comprises from 75 to 96 wt. % of vitreous silica, from 2 to 23 wt. % of chemical binder, and from 2 to 4 wt % of water.

11. The refractory article of claim 10, wherein the chemical binder is selected from a group consisting of calcium aluminate, calcium silicate, polyalkoxysiloxanes, colloidal silica, zirconium acetate, magnesium acetate, magnesium oxide an mixtures thereof.

12. The refractory article of claim 8, wherein the refractory article is sintered and comprises at least 60 wt. % amorphous silica.

13. The refractory article of claim 12, wherein the refractory article comprises more than 90 wt. % amorphous silica.

14. A process for the preparation of a refractory article comprising vitreous silica impregnated with a carbonaceous material, the process comprising impregnating a vitreous silica basis with a carbonaceous material.

15. The process of claim 14, wherein impregnation occurs by heating.

16. The process of claim 14, wherein impregnation occurs under pressure.

17. The process of claim 14, wherein impregnation is followed by cracking the impregnated carbonaceous material.

18. The process of claim 17, wherein cracking occurs by heating.

19. The process of claim 17, wherein cracking occurs under pressure.

20. A refractory article for guiding or conveying a solidified material comprising 75 wt. % vitreous silica including at least 60 wt. % amorphous silica impregnated with 1-6 wt. % carbonaceous material, and from 2 to 23 wt. % of chemical binder selected from a group consisting of calcium aluninate, calcium silicate, polyalkoxysiloxanes, colloidal silica, zirconium acetate, magnesium acetate, magnesium oxide an mixtures thereof.
